(19) United States
(12) Patent Application Publication
(10) Pub. No.: US 2004/0083465 A1
(43) Pub. Date: Apr. 29, 2004

(54) Method and system for connecting to an application programming interface

(76) Inventors: Weijia Zhang, Round Rock, TX (US); Richard Ball Landau, Austin, TX (US)

Correspondence Address: HAMILTON & TERRILE, LLP, P.O. BOX 203518, AUSTIN, TX, 78720, US

(21) Appl. No.: 10/281,793

(22) Filed: Oct. 28, 2002

(51) Int. Cl. G06F 9/45

(52) U.S. Cl. 717/143; 717/136; 719/328

(57) ABSTRACT

A translation layer connects a user program to an application programming interface by constructing function calls from a template text file that maps user program functions to application programming interface function primitives and by translating function call output received from the application programming interface to a user program format. The translation layer provides a programmable function-based connection that is able to alter the procedure and the semantics of data used to perform a function. For instance, a single user program function call may conditionally invoke plural application programming interface primitives. The translation layer improves flexibility in development of user programs by mediating with application programming interfaces through modifiable template text file and translation rules.

### BACKGROUND OF THE INVENTION

1. Field of the Invention

The present invention relates in general to the field of interfacing programs, and more particularly to a method and system for connecting a program to an application programming interface.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

The usefulness of information handling systems is enhanced by the use of compatible applications that run on different types of information handling systems. To aid in the development of compatible applications, application programming interfaces (API) and application servers are typically defined to provide a suite of routines and protocols for linking software components together. Once an application programming interface specification is defined and published, other programs that use the application programming interface may be developed to use the defined functions and name space of the application programming interface. The application programming interface then typically acts as interpretive layer that mediates between the user program and the defined application by ensuring that data shared between the user program and defined application is consistent. For instance, in a database management system, an application programming interface often transforms between a physical and record structure of a database schema and the logical structure of the views of user programs. Application programming interfaces basically convert data from one compiled version to another but generally lack any active or programmable component that changes procedures applied to data.

As software development has increased in pace and third party software leverage has become increasingly important to efficient software development, the conventional approach to specifying and implementing application programming function calls has faced a number of difficulties. For instance, to ensure programming consistency, application programming interface specifications are typically locked to use defined functions and name space, thus reducing the flexibility associated with application programming interfaces. As another example, increasingly complex software tends to rely on increasingly complex application programming interfaces that generally take longer to define, thus slowing the development and implementation of user programs that typically must wait until delivery of a specification before implementation and testing of the user program. Another example of a difficulty associated with conventional application programming interfaces is that application programming interface maintenance becomes increasingly complex over the development of different versions and development for different users. Consistency and compatibility generally must be maintained during development with any change to a function specification tending to require changes to software components that call the function, thus leading to recompilation of user program and application programming interface layers.

### SUMMARY OF THE INVENTION

Therefore a need has arisen for a method and system which reduces complexity and improves flexibility in interfacing user programs and application programming interfaces.

A further need exists for a method and system which adapts user programs and application programming interfaces to interact with minimal changes to existing specifications.

A further need exists for a method and system which aids contemporaneous development of a user program with an application programming interface used by the user program.

In accordance with the present invention, a method and system are provided which substantially reduce the disadvantages and problems associated with previous methods and systems for connecting a user program to an application programming interface. A translation layer merges user program function calls with a template text file to format the function call for an application programming interface. The output of the application programming interface in response to the function call is translated by translation rules to a format for return to the user program. The template text file and translation rules provide a programmable mechanism that allows a user program to adaptably connect with an application programming interface.

More specifically, a translation layer accepts function call requests from a user program through a user program function interface. The user program function interface lists the functions callable by the user program and provides requested functions and input data to a function constructor. The function constructor merges function call requests from the user program with a template text file to format the function for the application programming interface. The modified function is communicated to the application programming interface or to an application server as a remote function call by a connector. The connector receives the response to the function and provides the response output to a parser that applies the translation rules to the output to format the output for the user program. The re-formatted output is returned to the user program function interface to provide to the user program in response to the function call request. Adjustments to the connection between the user program and the application programming interface are made by updating the template text file and translation rules.

The present invention provides a number of important technical advantages. One example of an important technical advantage is that the present invention reduces complexity and improves flexibility in interfacing user programs and application programming interfaces. A function-based mechanism provides a programmable translation layer that is able to alter procedures and semantics of data to perform a function. The translation layer performs more than a fixed conversion of data fields and formats by applying a template text file and translation rules table to significantly alter algorithms to perform a function. Thus, rather than spending substantial time comporting a user program with exacting application programming interface specifications, user program developers are able to instead adapt a user program of their design through a flexible translation layer by defining the template text file and translation rules.

Another example of an important technical advantage of the present invention is that it adapts user programs and application programming interfaces to interact with minimal changes to existing specifications. A template text file adapts to call a different function with a substantially different calling sequence including calling multiple application programming interface primitive functions to perform a user program function request, and having the primitive functions conditionally executed depending upon data inputs and results. The translation layer template text file provides a flexible tool to re-map semantics of particular data values and representations for adapting application programming interface and user programs to communicate as the programs change and develop without changing the underlying application programming interface specification.

Another example of an important technical advantage of the present invention is that it aids contemporaneous development of a user program with an application programming interface used by the user program. User program developers specify their own functions as well as data input and output formats with a general goal of maintaining sufficient similarity with the underlying application programming interface so that a translation layer is able to mediate between the two program layers. As the user program and application programming interface are built and debugged, changes for compatibility are programmed through the translation layer by updating the template text file and translation rules. Further, with the greater cooperation available through joint development, user program developers face less complexity. For instance, rather than working with a comprehensive set of routines, user program developers can focus on a subset template of relevant functions that excludes functions not necessary to the user program.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a translation layer for translating between a user program and an application programming interface; and

FIG. 2 depicts a flow diagram for translating between a user program and an application programming interface.

### DETAILED DESCRIPTION

A flexible and programmable interpretive layer mediates between compiled layers running on an information handling system. Function call requests of a user program are merged with a template text file to format the function call requests for an application programming interface, and outputs in response to the function call requests are translated to return to the user program. The template text file and translation rules are modifiable to reduce the complexity of programming applications to interact on an information handling system. For purposes of this application, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

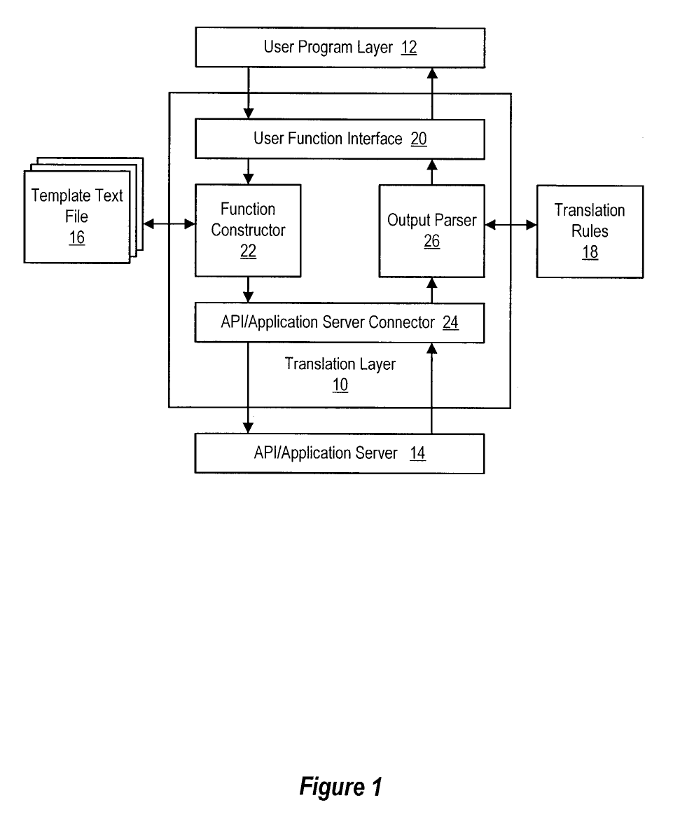

Referring now to FIG. 1, a block diagram depicts a translation layer 10 that mediates between a user program layer 12 and application programming interface (API) layer 14. When user program layer 12 requests a function call, the type and input data of the function is formatted by translation layer 10 to produce a modified request that is sent to application programming interface layer 14. The output of the modified function request is then received by translation layer 10 and translated by predefined rules to the format of user program layer 12. The control and output data from application programming layer 14 are then returned to user program layer 12.

Translation layer 10 mediates between user program layer 12 and application programming interface layer 14 by describing callable functions in one or more template text files 16 and by describing function results translations in a translation rules table 18. Template text file 16 describes data for function calls in sufficient detail to permit automated translation from a user program layer 12 format to an application programming interface layer 14 format. Template text file 16 maps user program layer functions to one or more application programming interface functions so that a given function request is able to call different functions with substantially different calling sequences, to call multiple functions to accomplish a desired result, to remap the semantics of particular data values and representations, and to conditionally call different functions depending upon data input and results output for called functions. Translation rules of translation rules table 18 apply to results received from application programming interface layer 14 to format results for user program layer 12. The translation rules apply one or more template text files to output received from application programming interface layer 14 to provide a programmable function-based mechanism. The programmable nature of translation layer 10 allows the altering of a procedure used to perform a function, the altering of semantics of data to perform a function, and the programmable altering of algorithms to accomplish a function.

Translation layer 10 communicates with user program layer 12 through a user function interface 20. User function interface 20 includes the functions callable by user program layer 12 to application programming interface layer 14. User function interface 20 provides the function type and input data for a user-program-requested function to a function constructor 22. Function constructor 22 is a class or routing that merges user program called function type and input data with template text file 16 to generate a function call request in the format for application programming interface 14. Function constructor 22 outputs a function call request string to application programming interface connector 24 which communicates the function call request to application programming interface 14. The response of application programming interface 14 to the function call request is received by application programming interface connector 24 and provided to output parser 26. Output parser 26 applies translation rules defined in translation rules table 18 to translate output from application programming interface 14 into a user-program specified format. The translated control and output data are returned through user function interface 20 to user program layer 12 in response to the function call request.

Template text file 16 specifies the relationship between user program functions and application programming interface functions with a text file that maps functions and inputs of the user program to functions and inputs of the application programming interface. For instance, a primitive function of user program layer 12 maps to a primitive function of application programming interface 14 as a template text file 16 expressed as an Extensible Mark-up Language (XML) schema. The XML schema maps data values for parameters of a call request from user program layer 12 to data values for parameters of call request formatted for application programming interface layer 14. However, a function call request from user program layer 12 may map to plural primitive function call requests of application programming interface layer 14. For instance, a composite function F maps to multiple application programming interface primitive functions as a chain of imbedded functions with conditional execution:

Composite F=Prim Fₙ(Prim Fₙ₋₁(Prim Fₙ₋₂. . . (Prim F₁))).

Alternatively, a composite function may call multiple primitive functions to produce a combined result:

Composite F=F (Prim Fₙ, Prim Fₙ₋₁, . . . , Prim F₁).

Further, template text file 16 may call application programming interface layer 14 primitive functions conditionally so that a determination whether to call primitive function depends upon the results from a previous primitive function call.

Template text file 16 and translation rules 18 are modifiable so that translation layer 10 provides an interpretive layer to mediate between compiled layers as a programmable mechanism. In one embodiment, user and application programming interface programs are separately developed to specify their own functions and data input and output formats with translation layer 10 modified to mediate the programs after development has progressed. In another embodiment, changes of application programming interface function and data inputs, such as a fix to a bug in a function call, are accomplished with a new or modified template text file that limits or avoids the need for rebuilding or recompilation of the programs. In another embodiment, template text files and translation rules help to lower the learning curve for developers to interact with an application programming interface by using only a relevant subset of the comprehensive set of routines available for the application programming interface. In addition, translation layer 10 supports remote function calls by implementing connector 24 to handle function call requests and responses to a remote application server.

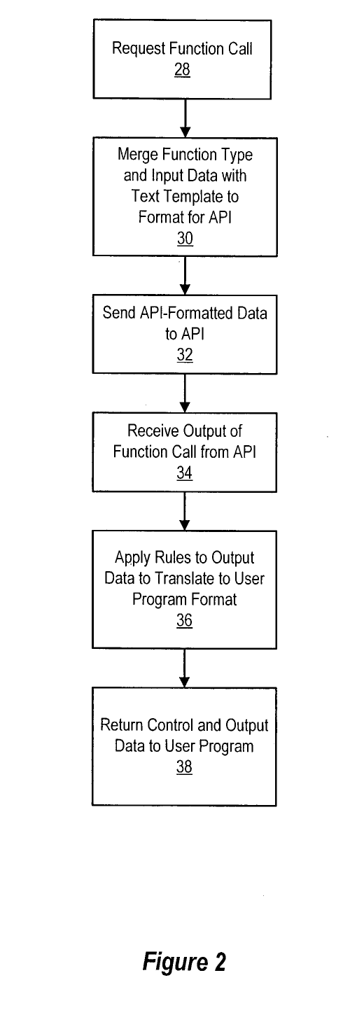

Referring now to FIG. 2, a flow diagram depicts the process for using translation layer 10 to mediate between compiled user program and application programming interface layers. At step 28, the user program 12 requests a function call. At step 30, the requested function type and input data are merged with a text template file to format the function call for the application programming interface 14. At step 32, the formatted data is sent to the application programming interface 14 and, at step 34 the output that results from the application programming interface is returned to the translation layer 10. At step 36, translation rules are applied to the output of the application programming interface 14 to translate the output to a user program format. At step 38, control and output data are returned to the user program to fulfill the function call request.

Although the present invention has been described in detail, it should be understood that various changes, substitutions and alterations can be made hereto without departing from the spirit and scope of the invention as defined by the appended claims.

What is claimed is:

1. A system for translating between a user program layer and an application programming interface, the system comprising:
a user program function interface having plural functions callable by the user program layer;
a template text file having a map of relationships between the functions and application programming interface functions;
a function constructor interfaced with the user program function interface and the template text file, the function constructor operable to apply the template text file to a function called by the user program to construct a function formatted for the application programming interface;
a connector operable to communicate the formatted function to the application programming interface and to receive a response from the application programming interface;
translation rules operable to translate application programming interface output to a user program format; and
a parser interfaced with the connector and the user program function interface, the parser operable to apply the translation rules to the application programming interface response to translate the response to a user program format.

2. The system of claim 1 wherein the application programming interface comprises an application server.

3. The system of claim 1 wherein the function constructor is further operable to apply the template text file to a user program function by combining plural primitive application programming interface functions.

4. The system of claim 1 wherein the template text file comprises encoded function maps for security.

5. The system of claim 1 wherein the template text file comprises a user program function operable to call application programming interface functions having a different calling sequence.

6. The system of claim 1 wherein the constructor is operable to apply the template text file to re-map the semantics of predetermined data values and representations between a client and server.

7. The system of claim 1 wherein the function constructor is further operable to apply the template text file to a user program function by conditionally executing primitive application programming interface functions.

8. The system of claim 7 wherein the conditional execution depends on a user program data input.

9. The system of claim 7 wherein the conditional execution depends on an application programming interface response.

10. The system of claim 1 wherein the template text file comprises an Extensible Mark-up Language schema.

11. The system of claim 1 wherein the template text file comprises a subset of application programming interface primitive functions that excludes primitive functions not called by the user program.

12. The system of claim 1 wherein at least one of the plural functions of the user program function interface comprises a remote function call.

13. A method for translating between a user program and an application programming interface, the method comprising:
requesting a function call by the user program;
merging function call type and input data with a text template to format the function call for the application programming interface;
sending the formatted function call to the application programming interface;
receiving output of the formatted function call from the application programming interface;
applying translation rules to the output to translate the output to a user program format; and
returning the translated output to the user program.

14. The method of claim 13 wherein merging further comprises merging the user program with plural application programming interface primitive functions.

15. The method of claim 14 wherein merging further comprises formatting the plural application programming interface primitive functions to conditionally execute depending on results returned from called application programming interface primitive functions.

16. The method of claim 13 further comprising:
modifying one or more application programming interface function and data inputs; and
updating the user program to communicate with the application programming interface by modifying the text template to format one or more user program function calls to use the modified application programming interface function and data inputs.

17. The method of claim 13 further comprising:
defining the text template to call a subset of less than all primitive functions associated with the application programming interface.

18. A medium readable by an information handling system, the medium storing instructions operable to translate between a user program and an application programming interface, the instructions comprising:
a text template operable to map user program functions to application programming interface functions;
translation rules operable to translate application programming interface output to a user program format;
a function constructor operable to accept user program function calls and to apply the text template to determine associated application programming interface functions; and
a rules parser operable to accept application programming interface output and to apply the translation rules to format the output for the user program.

19. The medium of claim 18 wherein the function constructor is further operable to apply the text template to associate a user program function call with plural application programming interface function primitives.

20. The medium of claim 19 wherein the association between the user program function call and the plural application programming interface function primitives comprises a conditional execution of at least one function primitive.
